(19) United States
(12) Patent Application Publication
(10) Pub. No.: US 2006/0048608 A1
(43) Pub. Date: Mar. 9, 2006

(54) Side-load nail holding hammer

(76) Inventor: Roland C Santa Ana, Rockville, MD (US)

Correspondence Address: Olds Maier & Richardson, 128 N Pitt St, Second Floor, Alexandria, VA, 22314, US

(21) Appl. No.: 10/542,990

(22) PCT Filed: Jan. 21, 2003
(86) PCT No.: PCT/US03/01768

§ 371 Date: Jul. 21, 2005

(51) Int. Cl. B25D 1/00

(52) U.S. Cl. 81/23

(57) ABSTRACT

An ergonomic side-load nail holding hammer for the industry of striking tools and hammers. It comprises a magnetic hammerhead including a multinail holder and starter, with half cone shaped vertical slots (such as 1a, 1b, 1c, 1d, 1e) with magnets (9) and self-releasing groove. It also permits nails to be straightened when hammered. It has curved shaped claws (6) for digging nails and preventing damage to the surface where the nail is located. The claw body (7) has a curved shape and the claws have a small claw end (5a) and a larger claw end (5b). The neck includes an indentation (3).

### TECHNICAL FIELD

This invention relates in general to hammers, in particular to nail & claw hammers and tack hammers. This invention is a novel ergonomic hammer that includes a multi-nail holder, slots that enable nails to be straightened when being struck or hammered, and curved claws for nail digging.

### BACKGROUND ART

The prior has diverse examples of nail and claw and tack hammers, all achieving distinct purposes. Nevertheless, none of the inventions present in the prior art disclose the invention subject of this application: a hammer that may magnetically retain or attract nail(s) of different size, length and width. In addition, many of the hammers in the prior art have the problem that a nail head may get caught with the head of the hammer during an up swing for striking or that the hammer head with a nail holding structure may get damaged during missed strikes to pointy objects or nails themselves, thus becoming dangerous.

U.S. Pat. No. 6,435,059 B1 (Martinez, 2002) describes a light-weight striking tool. The invention in the prior art includes a nail holder groove of magnetic qualities for holding a nail for easy setting. This invention differs from the side-load nail holding hammer because the nails that can be retained by the hammer in the prior art are limited in number, size and length, unlike the side-load nail holding hammer for various numbers of nails. In addition, the side-load nail holding hammer has nail slots of a half cone design. U.S. Pat. No. 6,339,974 B1 (Kotschner et al, 2002) pertains to a carpenter hammer with a hammerhead with a nail holder. U.S. Pat. No. 6,332,376 (Hurley, 2001) describes a hammer with replaceable nail striking head. U.S. Pat. No. 6,301,996 (Crawford, 2001) pertains to a nail-starting hammerhead. U.S. Design Pat. No. 438,082 (Stegner, 2001) concerns a hammer. U.S. Pat. No. 5,894,764 (Hanlon, 1999) is for a hammer with nail-holding structure. U.S. Pat. No. 4,465,115 (Palomera, 1984) is for a hammerhead. U.S. Pat. No. 4,193,433 (Siclder, 1980) is for a nail holding hammer. PCT published international patent application No. WO 01/12392 (August, 2001) discloses a lightweight striking tool. As in the previous examples, these prior art inventions can be applied only to nails of limited sizes, unlike the side-load nail holding hammer. In addition, in the particular case of U.S. Pat. No. 4,193,433, the nail head may get caught in the hammer claw at striking said tool, a disadvantage not shared by the side-load nail holding hammer. In addition, the side-load nail holding hammer has nail slots of a half-cone design, therefore having nail slots of a different shape.

U.S. Pat. No. 5,988,020 (Johnson, 1999) discloses a hammerhead used for magnetically holding nails of different sizes and lengths. This device does not permit the hammer to magnetically attract and retain several nails of different size, length and width for striking or hammering. In addition, this invention has a U-shaped striking bar, which may have to be replaced in the future. This problem is not present in the side-load nail holding hammer invention subject of this patent application. Moreover, this prior art invention does not magnetically attract the nails in the same manner as the side-load nail holding hammer does. The side-load nail holding hammer has numerous half cone shaped vertical slots in its face and back throat, for nails to be inserted therein. These nails are magnetically attracted to the small magnets placed on the sides of such slots. Therefore, these slots with the small magnets serve to magnetically attract the nails, thus acting as nail holders and nail starters.

U.S. Pat. No. 4,561,635 (Lamansky, 1985) discloses a nail-removing hammer. The side-load nail holding hammer has claw ends that also permit the removal of nails. In addition, the side-load nail holding hammer has claws that differ in shape from the hammer in the prior art for the side-load nail holding hammer has curved claws that dig deeper into the nail head.

U.S. Pat. No. 6,283,449 (Hu, 2001) discloses a hammer with a nail digging function. This hammer does not share the same shape of claw as the side-load nail holding hammer for the latter has curved shaped claws. In addition, due to the fact that both claws of the Hu invention are in line, one of the Hu hammer claws may obstruct the second while removing a nail, problem that is not encountered by the side-load nail holding hammer. Therefore, the side-load nail holding hammer protects surfaces from damage by any of its own claws.

Therefore, the present novel invention differs from those in the prior art because it permits numerous nails of different size, length or width to be placed in the half cone shaped slots in the hammer face and back throat, retained magnetically, and ready to be struck on a surface. In addition, it includes a hammerhead with a curved claw body, curved claws enabling removal of nails without damaging the nailed surface, and an indentation in the neck of the hammer.

### DISCLOSURE OF THE INVENTION

The present invention embodies a novel ergonomic side-load nail holding hammer. The elements of this invention are a striking tool or hammer comprised of:
(a) A handle.
(b) A hammerhead having an eye (10), a pair of curved claws (6), a curved claw body (7), throat (8), neck with an indentation (3) and striking face (2). The curved claws (6) have a small curved claw end (5a) and a larger curved claw end (5b), both to be used for nail digging and removal.
(c) Having said face (2) and throat (8) a nail holder and nail starter comprised of numerous half cone design vertical slots (such as 1a, 1b, 1c, 1d, 1e) permitting placement of numerous nails of diverse size, length and width; and having small magnets (9) attached or drilled on their sides, which shall magnetically attract the nails to the sides of such slots.

### OBJECTS AND ADVANTAGES OF THE INVENTION

The present invention constitutes a significant improvement in several aspects over such previously identified efforts of the prior art as described below.

An object of the present invention is to provide a novel hammer of ergonomic design for it includes a multinail holder and nail starter with vertical slots (such as 1a, 1b, 1c, 1d, 1e) at the side of the hammerhead throat (2) and face (8). Prior art hammers locate nail holder and/or starters at the top of the hammerhead or at the end of the hammer handle. Therefore, user may initially nail by striking the nail starter in those locations, and thereby continue nailing with the hammer face. However, it is awkward for user to change striking positions and therefore nailing is not done in the most efficient way. Thus, this novel invention solves the aforementioned problem, for user will use the side load nail starter and continue striking the nail, handling the hammer or striking tool in the same manner as when initially held. Hence, user shall perform nail starting, initial nailing and continued nailing in an ergonomic or natural manner, making this an efficient tool for hammering a nail in a comfortable way for user and preventing physical injury to user's wrist and elbow.

Another object of the present invention is to present us with a side-load nail holding hammer with a nail holder and nail starter capable of retaining or attracting and starting numerous quantities of nails of different size, width and length. The nail slots have a characteristic half cone design.

Yet another advantage of this invention is that it includes a nail-straightening slot. The half cone vertical slots (such as 1a, 1b, 1c, 1d, 1e) not only hold the nails for hammering and serve as a nail starter, but also maintain the nails in a straight position and therefore straighten them when they are hammered.

In addition, another advantage of the side-load nail holding hammer is making an improvement in nail digging claws. The side-load nail holding hammer has efficient curved shaped nail digging claws (6) with a small digging claw end (5a) and a larger digging claw end (5b) that shall not damage the surface from where the nail is being dug or pulled.

Yet another advantage of this invention is that its groove has a self-release design. This characteristic of the side-load nail holding hammer enables the nail to be immediately released after hammering, being self-released from the slot (such as 1a, 1b, 1c, 1d, 1e) of the nail holder/nail starter where it has been placed, and not being caught in or within the hammer.

### BRIEF DESCRIPTION OF DRAWINGS

The present application includes six drawings. The scope of the side-load nail holding hammer is however limited only by the scope of the claims not by a particular embodiment shown in the drawings.

FIG. 1 is a front upper view of hammerhead including the nail starter/holder with nail slots (1a) on the sides of the face, the throat (8), a rounded claw body (7), a pair of curved hammer claws (6). with a small claw end (5a) and a larger claw end (5b).

FIG. 2 is a side view of the hammerhead, including the nail starter/holder with nail slots (1a, 1b, 1c, 1d, 1e) for nails of diverse sizes, being located at the face (2) and back of the throat (8) of the hammerhead. It also illustrates small magnets (9) in the nail slots to magnetically attract the nails, a neck indentation (3), curved claw body (7), the larger claw end (5b), and the eye (10).

FIG. 3 is a bottom view of the hammerhead, including the bottom part of the face (4), the nail holder/starter including diverse half cone shaped nail slots (1a, 1b, 1c, 1d, 1e) for nails of different sizes, and the eye (10).

FIG. 4a is a top view of the hammerhead including a rounded claw body (7), a pair of claws (6), a small claw end (5a), a larger claw end (5b), and the eye (10).

FIG. 4B is a top view of the hammerhead. It includes a pair of claws (6), a small claw end (5a), a larger claw end (5b), and the eye (10).

FIG. 5 is a side view of the hammerhead and includes a rounded claw body (7), the eye (10), the throat (8), neck indentation (3), and the nail starter/holder at the face (2) and throat (8) including numerous half cone shaped nail slots (1a, 1b, 1c, 1d, 1e) and magnets (9). In addition, it has a larger view of a nail slot (1c) illustrating the half cone design of the nail slot, as well as a larger view of the magnets (9).

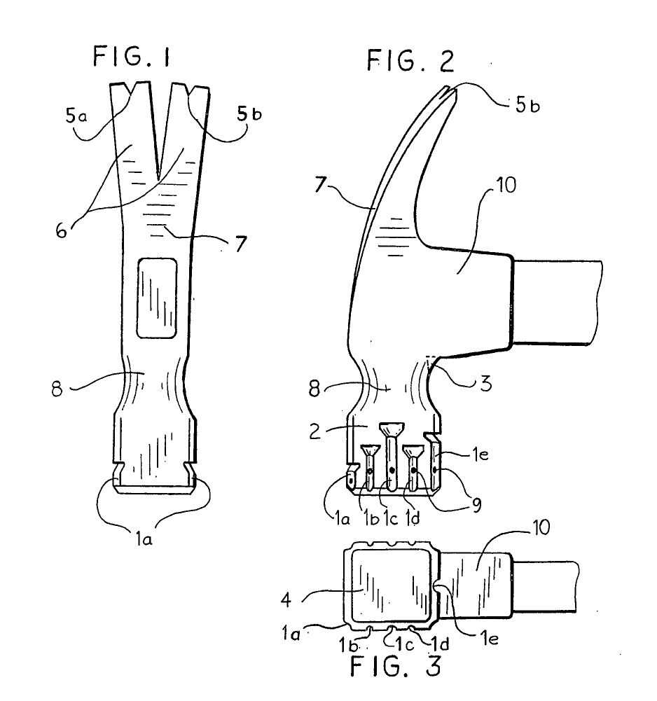

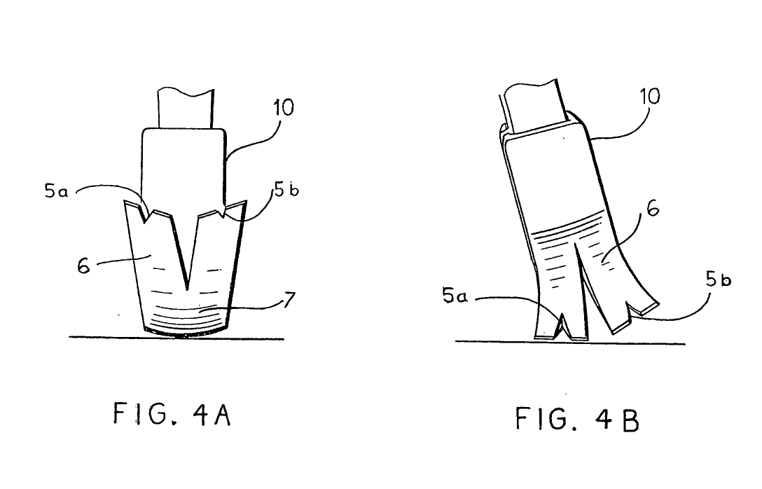

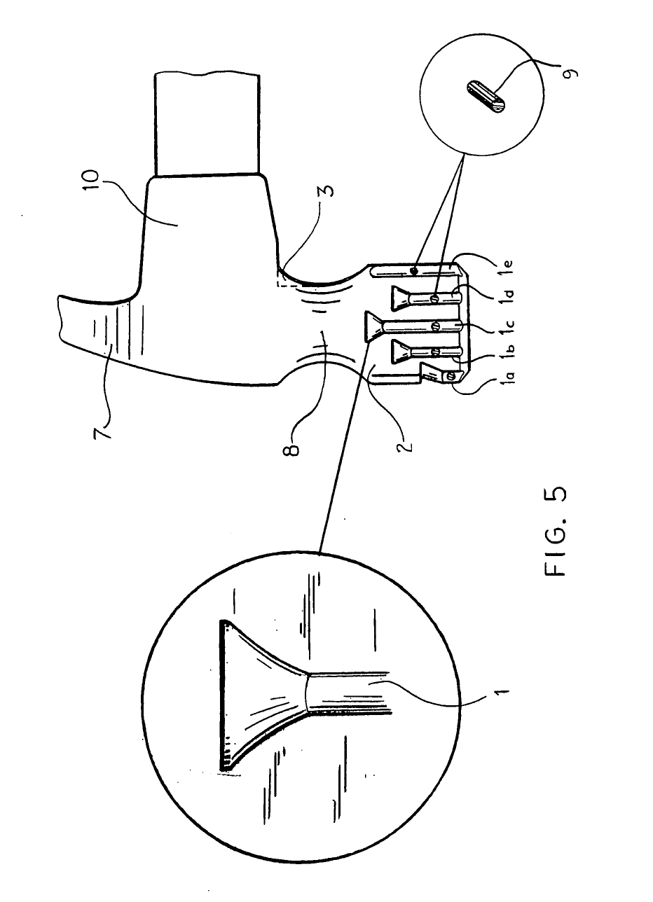

### DESCRIPTION OF PREFERRED EMBODIMENT/BEST MODE

The present invention embodies an ergonomic, magnetic, side-load nail holding hammer. The elements of this invention are:

(a) A handle made of metal, wood, fiberglass or man-made materials.

(b) A hammerhead made of metal having an eye (10), a pair of curved claws (6), a curved claw body (7), a throat (8), neck with an indentation (3) and striking face (2). The curved claws (6) have a small curved claw end (5a) and a larger curved claw end (5b), both used for nail digging and removal.

(c) Having said face (2) and throat (8) a nail holder and starter comprised of numerous half cone design vertical slots (such as 1a, 1b, 1c, 1d, 1e) for holding and starting nails for hammering, thereby permitting placement of nails of diverse size, length and width. The slots also have small magnets (9) drilled in them, therewith magnetically attracting the nails to the slots, and said slots also used for nail straightening when hammering and as a self-releasing groove.

Description of Alternate Embodiments

The present invention embodies an ergonomic, magnetic, side-load nail holding hammer. The elements of one embodiment of this invention are:

(a) A handle made of materials such as but not limited to metals such as but not limited to titanium; wood; fiberglass, rubber, plastic, or man made materials.

(b) A hammerhead made of metals such as but not limited to titanium and iron, having an eye (10), a pair of curved claws (6), a curved claw body (7), a throat (8), neck with an indentation (3), and striking face (2). The curved claws (6) have a small curved claw end (5a) and a larger curved claw end (5b), both used for nail digging and removal.

(c) Having said face (2) and throat (8) a nail holder and starter comprised of numerous nail halfcone design vertical slots (such as 1a, 1b, 1c, 1d, 1e) for holding nails, permitting placement of nails of diverse size, length and width. These slots have small magnets (9) attached or drilled to their sides or in them; therefore magnetically attracting the nails to said slots. These slots are also used for starting and straightening nails when hammering and as a self-releasing groove.

The invention is not however limited to the above embodiments and materials, for they are given as examples only. The scope of the invention should be determined by its claims not by a particular embodiment of the invention.

I claim:

1. A striking tool or hammer characterized by and comprising:
(a) A handle.
(b) A hammerhead including an eye (10), a pair of curved claws (6), a curved claw body (7), a throat (8), neck with an indentation (3) and striking face (2).
(c) Wherein the curved claws (6) have a small curved claw end (5a) and a larger curved claw end (5b), both used for nail digging and removal.
(d) Wherein the face (2) and throat (8) have a nail holder and starter comprised of numerous side vertical slots (including but not limited to 1a, 1b, 1c, 1d, 1e) for holding and starting nails for hammering, thereby permitting placement of nails of diverse size, length and width.
(e) Wherein said slots have small magnets (9) attached or drilled to their sides or inside the slots for magnetic attraction of nails to the slots, and said slots also used for straightening the nails when hammering and as a side self-releasing groove.

2. The striking tool or hammer described in claim 1, wherein it is comprised of:
(a) A handle made of materials such as but not limited to wood, metal, fiberglass, rubber, plastic or man made materials.
(b) A hammerhead made or materials such as but not limited to titanium, iron, and/or other metals, the hammerhead including an eye (10), a pair of curved claws (6), a curved claw body (7), a throat (8), neck with an indentation (3), and striking face (2).
(c) Wherein the face (2) and throat (8) include a nail holder and starter comprised of numerous side vertical slots (including but not limited to 1a, 1b, 1c, 1d, 1e) for holding and starting nails for hammering, thereby permitting placement of nails of diverse size, length and width.
(d) Wherein the slots have small magnets (9) attached or drilled to their sides or inside the slots, for attraction of nails to the slots, and the slots also used for straightening the nails when hammering and as a side self-releasing groove.

3. The striking tool or hammer described in claim 1, wherein said hammerhead is made of metal, and such vertical slots (including but not limited to 1a, 1b, 1c, 1d, 1e) conform a magnetic side nail holder.

4. The striking tool or hammer described in claim 2, wherein said hammerhead is made of metal, and such vertical slots (including but not limited to 1a, 1b, 1c, 1d, 1e) conform a magnetic side nail holder.

5. The striking tool or hammer described in claim 1, wherein said side nail holder and starter enables user to hammer nails ergonomically, holding the hammer on an elevated position and thereafter striking the intended surface; wherein the self-releasing groove releases the nails after striking the surface in an ergonomic manner.

6. The striking tool or hammer described in claim 2, wherein said side nail holder and starter enables user to hammer nails ergonomically, holding the hammer on an elevated position and thereafter striking the intended surface; wherein the self-releasing groove releases the nails after striking the surface in an ergonomic manner.

7. The striking tool or hammer described in claim 1 wherein the nail holder, starter and self-releasing groove includes a half conical shape design on top of each slot (including but not limited to 1a, 1b, 1c, 1d, 1e) or groove so as to slide off the nail head away from the hammer during upswing.

8. The striking tool or hammer described in claim 2 wherein the nail holder, starter and self-releasing groove includes a half conical shape design on top of each slot (including but not limited to 1a, 1b, 1c, 1d, 1e) or groove so as to slide off the nail head away from the hammer during upswing.

9. The striking tool or hammer described in claim 1 wherein the curved claws (6) with the small claw end (5a) and larger claw end (5b) are designed to dig deeper into a surface in order to capture the nail head and for a better grip during the nail extraction process.

10. The striking tool or hammer described in claim 2 wherein the curved claws (6) with the small claw end (5a) and larger claw end (5b) are designed to dig deeper into a surface in order to capture the nail head and for a better grip during the nail extraction process.

11. The striking tool or hammer described in claim 1 wherein the curved claws (6) include a claw end (5a or 5b) in each claw respectively, being these claw ends (5a and 5b) used as multinail diggers intended for the extraction of nails of various sizes, wherein these nails are imbedded into the surface to be extracted and not obstructed by the other claws during the process of nail extraction.

12. The striking tool or hammer described in claim 2 wherein the curved claws (6) include a claw end (5a or 5b) in each claw respectively, being these claw ends (5a and 5b) used as multinail diggers intended for the extraction of nails of various sizes, wherein these nails are imbedded into the surface to be extracted and not obstructed by the other claws during the process of nail extraction.

13. The striking tool or hammer described in claim 1 wherein the curved claws (6) include claw ends (5a and 5b) in each pair of claws, being these claw ends designed to extract nails in a tight corner and from difficult areas such as but not limited to shoe mold floor or wall trim, corner wall trim, ceiling or wall corner trim such as but not limited to crown molding.

14. The striking tool or hammer described in claim 2 wherein the curved claws (6) include claw ends (5a and 5b) in each pair of claws, being these claw ends designed to extract nails in a tight corner and from difficult areas such as but not limited to shoe mold floor or wall trim, corner wall trim, ceiling or wall corner trim such as but not limited to crown molding.

15. The striking tool or hammer described in claim 1 wherein the design of the side load nail holding hammer permits user to visually observe whether the nail is correctly placed in its slot or groove to prevent accidental dislodgement of the nail.

16. The striking tool or hammer described in claim 2 wherein the design of the side load nail holding hammer permits user to visually observe whether the nail is correctly placed in its slot or groove to prevent accidental dislodgement of the nail.
